(19) United States
(12) Patent Application Publication
(10) Pub. No.: US 2006/0232059 A1
(43) Pub. Date: Oct. 19, 2006

(54) Thermochromic decals for moist or wet environments with changing temperatures

(76) Inventors: Robert Gordon McKay Fortune, Scottsdale, AZ (US); Scott James Fergus, Santa Ana, CA (US)

Correspondence Address: THE LUTHER LAW FIRM, 12198 E. COLUMBINE DR., SCOTTSDALE, AZ, 85259, US

(21) Appl. No.: 11/175,107

(22) Filed: Jul. 5, 2005

Related U.S. Application Data
(60) Provisional application No. 60/671,190, filed on Apr. 14, 2005.

(51) Int. Cl. B42D 15/00

(52) U.S. Cl. 283/72

(57) ABSTRACT

A polylaminated, waterproof, thermally-sensitive decal has a waterproof base that is adhesive on its outer surface and printable on its inner surface; an advertising image printed on the inner surface; a printable covering that overlays the advertising image; a layer of thermochromic ink on the printable covering such that the thermochromic ink is opaque at room temperature but is translucent at increased temperature; and a waterproof layer designed to overlay and protect the thermochromic ink in a moist or wet environment. The decals are designed to fit within the confines of a urinal and to act as a target for the user. The decals are easily applied and removed and are intended for use in moist or wet environments. Also disclosed is a method of advertising. The method includes providing a decal comprising a plastic layer that is adhesive on one surface and printable on its second surface; an advertising image or slogan printed on the second surface, a printable covering that overlays the advertising image, a layer of thermochromic ink such that the thermochromic ink is opaque at room temperature but is translucent at increased temperature in a moist or environment, and a waterproof layer designed to overlay the thermochromic ink; placing the decal in a urinal at a height above the fluid level, but near the fluid level for the higher-temperature urine to contact the decal; and replacing the decal periodically to coincide with new advertising campaigns.

### RELATED PATENT APPLICATIONS

This application claims the benefit of U.S. Provisional Application No. 60/671,190 filed Apr. 14, 2005.

### BACKGROUND

A recognized conceptual model for creating a successful advertisement or marketing campaign is the AIDA model: (1) get Attention; (2) hold Interest; (3) arouse Desire, and (4) obtain Action. Although many advertisements capture the audience's attention, very few hold interest, arouse desire, and obtain action, often because these advertisements compete against numerous other advertisements and environmental distractions (“noise”).

Retail and service companies spend extraordinary amounts of money to produce and display advertisements that reach a large target audience and promote interest, such as the television commercials that are developed specifically for airing during the Super Bowl. The cost of such advertisements and marketing campaigns is justified by the size of the target audience and the level of interest and desire in the product or service that is created. Identifying and reaching the appropriate target audience is critical to creating a successful advertisement and developing a marketing campaign that delivers action by consumers.

Advertisements and marketing campaigns are individually crafted to appeal to specific audiences and their differing needs and desires. For example, television advertisements and commercials for the same product or service vary depending on the time of airing, the channel, and the expected demographics of the audience viewing the advertisement or commercial. Because of intense commercial competition, retail and service companies are continuously searching for new advertising and marketing ideas, more effective media for message delivery, and innovations that result in attention, interest, desire, and action with regard to the product or service being offered. Men are an important target of marketing campaigns.

One excellent location for capturing the attention of men for an advertisement is the men's restroom. The men's restroom is relatively free of competitive distractions, the target market is clearly identified and limited, and the cost to implement an advertisement is relatively inexpensive.

Relevant patents disclosing the use of urinals for the purpose of conveying information to the users of urinals include U.S. Pat. Nos. 5,809,590 and 5,867,848. Both of these patents disclose the use of thermochromic images or text messages to display unrevealed advertisements, pictures or information when a warm urine stream activates the thermochromic ink, causing the ink to convert from an opaque to translucent state, thus revealing an otherwise invisible image or text message. The process by which thermochromic ink converts from an opaque to translucent state is completely reversible with temperature reduction, which occurs when the urinal is flushed with cool rinse water. U.S. Pat. No. 5,809,590 discloses a urinal mat that contains a thermally-sensitive image or text message and reduces splash back by the incorporation of apertures and protrusions. In addition to displaying the image or text message upon activation, the mat serves to guide urine flow and prevent splash back. Such a device is large and expensive to produce and to change.

U.S. Pat. No. 5,867,848 discloses a display apparatus to present the image or text message. The disclosed apparatus is a urinal screen that is shaped such that the screen lies at the bottom of a urinal at a specific angle above the horizontal and above water level with said screen holding a thermochromic image or text message. Both of these patents disclose the use of larger devices to convey the displays. Disadvantages of these devices include the fact that they are large, bulky, and labor intensive and expensive to change.

Thermochromic ink has been used in numerous products to indicate temperature or to serve as a security indicator. For example, U.S. Pat. No. 5,820,951 discloses the use of thermochromic ink in a beverage container to display temperature. U.S. Pat. No. 5,389,093 discloses the use of thermochromic ink in baby diapers, which upon becoming wet, cause the appearance of printing on the surface of the diaper. U.S. Pat. No. 6,670,436 discloses the use of thermochromic ink to distinguish dental materials from natural dentin.

Urinal mats and screens containing highly specific displays, such as advertisements, comprise an undesirable medium for conveying information to a man. While the mats and screens serve a useful function by reducing urine splash back while the urinal is in use, the mats and screens are large and cumbersome and pose a significant challenge during cleaning and maintenance to assure proper positioning and hygiene. In addition, mats or screens that contain an advertisement, while initially useful, become a liability with time, because the message may be destroyed by scrubbing and the screens cannot be easily modified, if at all, to convey a new message. Thus, they need to be replaced. Replacement costs are substantial in newly printed mats and labor and disliked by business owners. Business owners prefer low fixed costs that are not recurring and prefer low-cost alternatives for changing and recurring expenses. The present invention offers these attributes.

### SUMMARY OF THE INVENTION

In one embodiment, a waterproof, thermally-sensitive decal has several layers, including a waterproof plastic layer that is adhesive on its outer surface and printable on its inner surface, an advertising image printed on the inner base surface, a printable covering that overlays the advertising image. A layer of thermochromic ink is printed on the printable covering. The thermochromic ink is opaque at room temperature but is translucent at increased temperature. The top waterproof layer is selected to overlay and protect the thermochromic ink in a moist or wet environment.

In another embodiment, the thermochromic ink covers less than the entire decal, so that at least one region of the decal does not change when the thermochromic ink is activated by increased temperature. Optionally the thermochromic ink becomes translucent at increased temperature and becomes opaque after heat dissipates. Optionally the adhesive is applied to the base outer surface and binds firmly in a moist or wet environment but is readily removable. Optionally, the thermochromic ink is cured by ultraviolet light and is protected from the moist or wet environment with a waterproof overlay. Optionally, an unrevealed printed image or text message for use in moist or wet environments can be used in a urinal, a shower, a bathtub, a spa, a steam room or a toddler's commode. Optionally, the decal displays advertising or public service messages. Optionally the decal is affixed to a plurality of urinals to display advertising or public service messages.

Optionally, the polylaminate decal has an unrevealed printed image or text message, thereby offering a cost-effective medium for advertising and/or marketing. Optionally The polylaminate decal has an unrevealed printed image or text message in a less expensive, more adaptable, and highly competitive alternative.

In another embodiment, there is provided a method of advertising. The method of advertising begins with providing a decal with a plastic layer that is adhesive on one surface and printable on its second surface; an advertising image or slogan printed on the printable surface, a printable covering that overlays the advertising image, a layer of printed thermochromic ink such that the thermochromic ink is opaque at room temperature but is translucent at increased temperature, and a clear plastic layer selected to overlay the thermochromic ink. The next step is placing the decal in a urinal a short distance above the fluid level, but near the fluid level for the higher-temperature urine to contact the decal; the final step is replacing the decal periodically to coincide with new advertising campaigns.

Optionally, the decal has an unrevealed printed image or text message that is an advertising and/or marketing tool for a specific audience. Optionally the provided polylaminate decals have unrevealed printed image or text message for a cost-effective medium for advertising and marketing.[0014] Still other objects, advantages and distinctions of the invention will become more apparent upon reference to the following description and the appended drawings. The description should not be literally construed in limitation of the invention, but instead should be interpreted to include all equivalent constructions within the scope of the appended claims.

### BRIEF DESCRIPTION OF THE DRAWINGS

FIG. 1 is a cross section of the inventive sticker or decal that shows five distinct layers, excluding the adhesive and its protective covering.

FIG. 2 is a diagram of a typical urinal that shows the point of placement of the inventive sticker or decal.

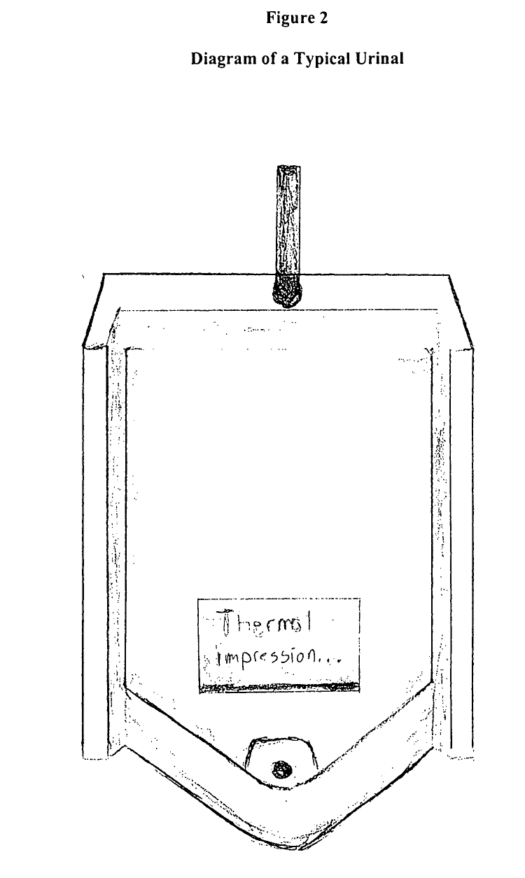

### DETAILED DESCRIPTION

The inventive decals have significant advantages compared to screens and mats in displaying advertisements in urinals. The smaller and less costly sticker or decal can be replaced easily, which offers the advantage of readily changing advertisements without requiring relatively expensive labor of replacing mats or screens. The decals are placed on the back of the urinal, slightly above the base of the urinal or the screen/mat in the urinal. The inventive stickers or decals continue the appeal of the advertisement, maintain the interest of the target audience, adapt to changes and modifications in the marketing campaign, and change the product or service that is the subject of the advertisement. Because most individuals frequent the same eating and dining establishments repeatedly, the target audience would be exposed to the same advertisement repeatedly. By using the inventive stickers or decals in urinals, bars and dining establishments will be able to easily remove and reapply new advertisements with ease and without the difficulty of replacing large, costly screens or mats. In addition, the thermally-sensitive decals are suitable for use in a variety of urinals of differing configurations and sizes, because a proper fit is not required. This feature is critically important to support large marketing campaigns that would utilize a multitude of urinals of different sizes and configurations.

Besides urinals, thermochromic decals can be used in sinks, bathtubs, showers and health clubs to obtain the interest of both sexes. Decals in sinks can carry a message rewarding the washer with a picture or message encouraging hand washing.

This invention is a polylaminated, waterproof decal for use in moist or wet environments that dynamically changes from displaying one image at ambient, room temperature or below to reveal a second, different image or text message; and the invention relates to marketing and advertising, specifically the use of thermally-sensitive decals in new, innovative media and locations.

The invention utilizes the properties of thermochromic inks. Thermochromic inks become translucent as their temperature increases. These color-changing inks all work the same way: below the activation temperature they are colored, and above the activation temperature they are clear or lightly colored. As the ink cools, the original color returns. Low temperature ink is used for applications in the refrigeration temperature range, like beverage labels and ice-cream packaging. Body temperature ink is designed to show color at normal room temperature and to change when rubbed with the finger or by breathing on it. It is used on packaging and other interactive products. High temperature formulation changes color just below the pain threshold temperature for skin, and is used on safety labels, microwaveable products, and hot beverage labels. Thermochromic inks are available from Chromatic Technologies, Inc. (Colorado Springs, Colo.), H.W. Sands Corp. (Jupiter, Fla.) and other manufacturers.

The invention requires a plastic to water-proof the decal to prolong the life of the decal in wet environments. The plastic also needs to be clear to allow the underlying colors to show. Clear plastics include polyvinyl chloride, polyurethane, low density (LD) polyethylene, high density (HD) polyethylene, polystyrene, polypropylene and polyester. Some of these plastics are sufficiently waterproof at increasing thicknesses. These plastics are available from a variety of manufacturers.

An adhesive is necessary to position and maintain position of the decal on porcelain, steel and other surfaces that one might want to use. Also the adhesive must be easy to remove, so that the decal can be quickly replaced, preferably without the use of a solvent. A variety of adhesives are available from general chemical manufacturers as well as specialty houses. Adhesives also are available from distributors who provide adhesives from a variety of manufacturers. For steel surfaces, an alternative way to maintain the position of the decal incorporates the use of magnetic patches or strips. The entire surface or only a portion of the decal backing can be covered with the magnetic patch.

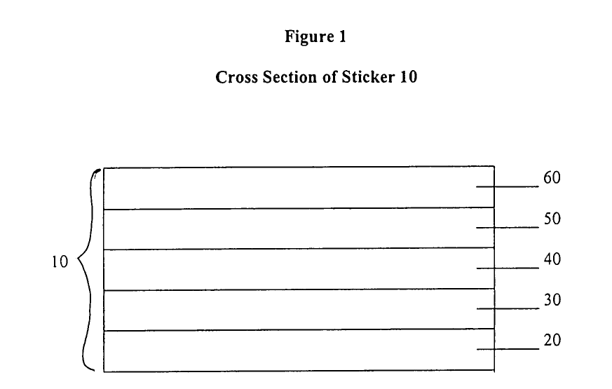

The invention is a polylaminated, waterproof decal for use in moist or wet environments that utilizes thermochromic ink such that the decal displays one image in its opaque state, and upon warming, reveals a second, different image or text message when the thermochromic ink is activated to its translucent state. The decal 10, in its preferred embodiment, is composed of five layers, as shown in FIG. 1. The base of the decal or decal is a plastic layer 20, to which a waterproof adhesive and a removable protective cover are added. The base may be comprised of vinyl, polypropylene, white film facestock or other suitable materials. The second layer is a printed image or text message 30 which is revealed only when the overlying thermochromic ink dynamically changes from an opaque color to translucent when exposed to a higher temperature. This image or text can be printed using a variety of inks. The third layer is a protective cover 40, composed of various materials. The fourth layer 50 is an image printed with thermochromic ink selected by one skilled in the art to dynamically change from opaque to translucent upon exposure to a predetermined higher temperature. The ink used in this invention is opaque at ambient, room temperature and translucent at higher temperatures, such as body temperature (98.6° Fahrenheit or 37 Celsius). The fifth layer 60 is a thin, waterproof covering that protects the thermochromic ink and the decal in moist or wet environments.

The inventive decals are suitable for use in urinals to promote specific products or services by displaying images or text messages when activated by warm urine. Alternatively, the inventive decals can be used to display public service messages, such as positive feedback for hand washing. The use of heat-sensitive decals in urinals is an extremely interesting and innovative concept that has not previously been exploited or disclosed.

The inventive sticker or decal preferably is installed in the optimum location of a urinal to reduce splash back and improve cleanliness of the urinal and its environment. Urinals are designed with a concave back wall that the urine stream should hit to contain urine and minimize splash back. The decal is installed at this optimum location and creates a target for users. The man directs his urine stream at this target, thereby reducing urine splash back, which results in improved hygienic conditions and cleaner restrooms. [0026] The decals are placed on the back walls of urinals, thus creating targets at which the urine stream is directed.

When a man approaches the urinal, he will immediately notice the decal, as it will be displayed in the conspicuous location where men will immediately direct their attention. When the man begins to urinate, the heat of the urine stream, which approximates body temperature (98.6° Fahrenheit or 37° Celsius), activates the thermochromic decal, which becomes clear to reveal a second image and/or text message. When the man has completed urinating, the act of flushing the urinal with cool water cools and cleans the decal and returns the thermochromic ink to its opaque state, ready for the next man. The dynamic change in the appearance of the decal captures the man's attention, retains his interest through personal interaction with the dynamic effects of the invention, and creates a highly positive and lasting impression from the innovative changes in the decal.

The application of the inventive decals is not limited to urinals. The decals can be used in any moist or wet environment with changing temperatures. For example, the inventive decals can be applied in showers, bathtubs, non-slip shower mats and to shower curtains or doors where the decal is opaque at ambient temperature but reveals a second image or text message when the translucent state is induced by contact with steam or warm water. Thus, the dynamic change from an opaque to translucent state occurs while the shower is in use. Likewise, the decals are ideal for placement in spas and steam rooms. Alternatively, the inventive decals can be placed in toddler commodes to encourage toilet training or in sinks to reward toddler hand washing.

This example is not intended to limit the scope of applications for this invention, but rather is presented to exemplify how one of ordinary skill in the art can study this invention, including the description and the accompanying drawings, and identify other applications, modifications, and advantages. For example, the decal can be formed of a variable number of layers, some of which are printed, and others are clear.

1. A polylaminated, waterproof, thermally-sensitive decal comprising
a. a waterproof plastic base that is adhesive on its outer surface and printable on its inner surface;
b. an advertising image printed on the inner surface;
c. a printable covering that overlays the advertising image;
d. a layer of thermochromic ink on the printable covering such that the thermochromic ink is opaque at room temperature but is translucent at increased temperature; and
e. a waterproof overlay designed to protect the thermochromic ink in a moist or wet environment.

2. The polylaminated decal of claim 1, wherein the thermochromic ink covers less than the entire decal, such that at least one region of the decal does not change when the thermochromic ink is activated by increased temperature.

3. The polylaminated decal of claim 1, wherein the thermochromic ink, having become translucent at increased temperature, becomes opaque after heat dissipates.

4. The polylaminated decal of claim 1 wherein an adhesive is applied to the base outer surface and is covered by a non-stick material.

5. The polylaminated decal of claim 1, wherein the adhesive binds firmly in a moist or wet environment but is readily removable.

6. The polylaminated decal of claim 1, wherein the thermochromic ink has been cured by ultraviolet light.

7. The polylaminated decal of claim 1, further comprising an unrevealed printed image or text message for use in moist or wet environments comprising a urinal, a sink, a bathtub, a shower, a spa, a steam room or a toddler's commode.

8. The polylaminated decal of claim 1, wherein the decal displays an advertising or public service message.

9. The polylaminated decal of claim 8, wherein the decal comprising an unrevealed printed image or text message are affixed to a plurality of urinals to display the advertisement or the public service message.

10. The polylaminated decal of claim 8, wherein the decal is placed in sinks, bathtubs, showers, spas, steam rooms or toddlers' commodes.

11. A method of advertising, the method comprising
a. providing a decal comprising a plastic layer that is adhesive on one surface and printable on its second surface, an advertising image or slogan printed on the printable surface, a printable covering that overlays the advertising image, a layer of printed thermochromic ink such that the thermochromic ink is opaque at room temperature but is translucent at increased temperature, and a waterproof layer selected to overlay the thermochromic ink;
b. placing the decal in a urinal at a short distance above the fluid level, but sufficiently near the fluid level for the higher-temperature urine to contact the decal; and
c. replacing the decal periodically to coincide with new advertising campaigns.

12. The method of claim 11, wherein the polylaminate decal comprises an unrevealed printed image or text message that is an innovative advertising and/or marketing tool for a specific audience.

13. The method of claim 11, wherein the polylaminate decal comprises an unrevealed printed image or text message for a cost-effective medium for advertising and/or marketing.

14. The method of claim 11, wherein the polylaminate decal comprises an unrevealed printed image or text message in a less expensive, more adaptable, highly competitive alternative.
